(19) United States
(12) Patent Application Publication
(10) Pub. No.: US 2006/0157558 A1
(43) Pub. Date: Jul. 20, 2006

(54) Infoscan

(76) Inventor: Thomas E. Finucan JR., Port Deposit, MD (US)

Correspondence Address: THOMAS E FINUCAN JR, 11 TWIN DRIVE, PORT DEPOSIT, MD, 21904, US

(21) Appl. No.: 11/039,657

(22) Filed: Jan. 20, 2005

(51) Int. Cl. G06K 5/00

(52) U.S. Cl. 235/380

(57) ABSTRACT

This idea integrates the use of a secure computer program for the storage and retrieval of personal information. It consists of a portable system such as a small scanner with the capacity of reading a credit card sized object, which contains the information to be secure. This information carried in compact form on one's person can be accessed at anytime or place emergently or otherwise. There will be various levels of access codes, which can be utilized by individuals with the appropriate security level. The material on the portable object could be the complete medical information of an individual imprinted on the card, which could be accessed by EMT's in the field, hospitals, or physician offices. The data is date specific and can only be updated but not altered. Information can now be available, shared as needed, and stored securely eliminating volumes of paper.

The name of this invention is infoscan. The basic premise is the coded inscription of information on a card the same dimensions as a credit card that is security protected. It will contain various levels of priority so that access of information is achieved on a need to know basis. The initial area of the card will address the availability and transmission of personnel medical information, which will contain a graphics program to provide the most recent EKG's, and x-rays. The levels of access will begin with basic information but will contain the most pertinent medical information that may be required in the field (for an emergency medical tech.) or a hospital setting. The program will provide software, which will lock in any new imputed information as to the day and time so that it cannot be altered other than to add new data to the existing medical file. This can stream line medical records in the office. Each institution will have a specific access code, which will allow them entrance to the emergency medical information according to the level of care they render. The card may be utilized at a later date to hold fingerprints and vital statistics of young people to have a database if they are lost, kidnapped or runaways. The card can be utilized in virtually all areas of human information gathering and dissemination for example but not limited to accounting, last will and testament, or advanced directives. Each individual can now have the security of carrying their medical history, allergies, drug reactions and unique information pertinent to their treatment of life threatening illnesses.

In summary this is a method to make personal information portable. We have designed a scanner card named infoscan that is about the size of a credit card. The card can be carried by individuals and will contain pharmaceutical history, physical history, EKG's, laboratory values and important radio logic information including copies of the actual films. The card will store in short the most vital patient information necessary for treating a patient in both an office as well as an emergent situation. This is only the medical implication for this invention but it obviously can be applied to business or any other walks of life. The card will remain extremely secure and will be locked with access allowed only by approved health care providers and their associates. Information changes will not be allowed; only additions to information and new information will be accepted.

The basic design of the card involves a computer software program that (a example of is provided with this documentation) will be available to hospitals, physician offices, and emergency personnel. The card can be carried by patients and when given to approved healthcare providers, will allow the providers to have immediate access to their most current and necessary medical information. The manner of carrying the information need not be confined to a card but could be encrypted on a bracelet, key chain or other modality with an access port. This will revolutionize health care by stream lining the accuracy of pre-treatment knowledge and diagnosis. This will save valuable time when that time will be live saving. It will help eliminate the deluge of paper work in existence. Every individual may now have the peace of mind to know that they carry information which may be life saving with them at all times. Individuals who have living wills will be spared the unnecessary pain and suffering of unwanted heroic measures. An individual may simply have anything encoded on the card that he feels if lost or needed in an instant can be retrieved. This is an idea whose time has come. We can improve the transmission of information and help to insure that medical treatment is comprehensive and availably by removing the guesswork.

1. The legally protected claim is the use of a credit card sized card that fits in a wallet or purse where information (ex. Medical, personel information, accounting information or other etc.) can be imputed, added to or accessed by authorized carriers or users of the card (individuals themselves, hospitals, physicians, law enforcement agencies etc); the protection would extend to any other modality that can be used to imprint a program on a portable but small area (ex. Key chain, bracelt etc); There will be different levels of security clearance where data can only be added and not changed by for example the individual's primary care provider; this card or medium acts as an example to provide the medical history, pharmaceutical history, and various medical problems that an individual is or has been treated for; this information can be retrieved when the card or device is scanned with the appropriate access code for the user of the program; the best example would be an unconscious individual in an emergency room setting; any other vital information that the person is interested in having on his person at any time would for example have a low priority and would allow the individual to update that himself; the soft ware program is a user friendly secured system which provides different screens to chose from where a medical professional could reach the most necessary and life saving current information needed to facilitate his diagnosis.
